(19) United States
(12) Patent Application Publication
(10) Pub. No.: US 2016/0107678 A1
(43) Pub. Date: Apr. 21, 2016

(54) DRIVER ASSISTANCE SYSTEM AND DRIVER ASSISTANCE METHOD WITH POSITION CONTROL

(71) Applicant: SCHAEFFLER TECHNOLOGIES AG & CO. KG, Herzogenaurach (DE)

(72) Inventors: Raphael Fischer, Herzogenaurach (DE); Tobias Vogler, Herzogenaurach (DE); Nicole Denzler, Erlangen (DE)

(73) Assignee: Schaeffler Technologies AG & CO. KG, Herzogenaurach (DE)

(21) Appl. No.: 14/890,803

(22) PCT Filed: Apr. 16, 2014
(86) PCT No.: PCT/DE2014/200174

§ 371 Date: Nov. 12, 2015

(30) Foreign Application Priority Data
Jun. 25, 2013 (DE) 10 2013 212 031.1

(51) Int. Cl. B62D 5/04

(52) U.S. Cl. CPC B62D 5/0457

(57) ABSTRACT

A driver assistance system (1) for a motor vehicle (2) is provided including a control device (3), with the control device (3) being designed to carry out a position control of the driving movement of the vehicle. The invention also relates to a method for assisting the driver of a motor vehicle (2), in which the following step is carried out: a position control of the driving movement of the vehicle is carried out by a control device (3).

### FIELD OF THE INVENTION

The invention relates to a system for driver assistance for a motor vehicle that has a control device, as well as to a method for assisting the driver of a motor vehicle.

### BACKGROUND

In motor vehicles (including internal combustion engine motor vehicles, especially electric and hybrid vehicles) as per the prior art, the torque is generated corresponding to the driver's wishes. While maneuvering, however, this can be a hindrance, because the driving resistance can vary greatly due to driving over obstacles, e.g., curbs, and the driver must quickly adapt the torque request accordingly. Thus there is the technical problem of developing a device and a method that make maneuvering easier for the driver.

### SUMMARY

This objective is achieved according to the invention especially by a system (1) for driver assistance for a motor vehicle (2) that has a control device (3), wherein the control device (3) is designed to perform position control of the driving motion of the vehicle.

This objective is also achieved according to the invention by, in particular, a method for assisting the driver of a motor vehicle (2), wherein the following step is performed:
executing position control of the driving motion of the vehicle by means of a control device (3).

For better controllability of the driving position while maneuvering, in particular, for electric and hybrid vehicles that can maneuver under electromotive force, position control is proposed. The invention is also applicable to vehicles with internal combustion engines. The vehicle thus can be moved independent of the prevailing driving resistance to the position desired by the driver. After activating the position control, e.g., by pressing a switch for the maneuvering operation, by means of the preferred operating device described below, a position-controlled maneuvering is performed.

The system according to the invention is preferably designed to perform the processing steps or functions described below, while the method according to the invention preferably contains steps that are provided by the functions of the individual system components.

Preferably, position control is performed as soon as a switch has been actuated by the driver or as soon as the system has automatically recognized that a parking or maneuvering process has begun. Preferably, the position control is performed as soon as the driver inputs a position request into the system, e.g., by actuating one or more operating elements. In the course of the position control, preferably an actual value of the vehicle position is compared with the desired value of a vehicle position and the difference between the desired value and the actual value is brought below a control tolerance value by means of the set value for controlling the drive device of the vehicle. Here, the vehicle is moved according to the set value or the desired value specifications.

The system for driver assistance for a motor vehicle is preferably designed to support the driver during a parking process or while maneuvering. It can preferably be actuated by means of a switch, preferably manually by the driver. In an especially preferred way, it can be actuated by an automatic system by means of which the beginning of a parking or maneuvering process can be recognized.

The control device is realized, e.g., by an analog or hybrid electronic circuit or by means of a program that can be executed on a computational unit of the vehicle, e.g., engine control module or an onboard computer. The control device can be preferably coupled with the drive unit or a control unit for the drive unit of the motor vehicle (e.g., by means of a signal cable) and is can be influenced, in particular, controlled by at least one parameter of the control device of the mode or operating state of the drive unit. The parameter is preferably, e.g., the fuel feed (e.g., in the case of an internal combustion engine) and/or the electrical energy feed (e.g., in the case of an electric motor), e.g., current and/or voltage, and/or the power transfer in the transmission and/or in the clutch (e.g., in the case of an automatic transmission).

The control device is designed to perform position control of the driving motion in that it is preferably designed to compare an actual value of a vehicle position with a desired value of a vehicle position (or to calculate a difference or standard deviation) and to output at least one parameter that is dependent on the result (e.g., using a regulator, e.g., a standard PID regulator), which has the result of adjusting the actual value to the desired value. Here, the vehicle is preferably moved in the position control operation by the drive unit until the actual value and desired value are adjusted or the standard deviation is within a selectable/selected tolerance range. Preferably, by means of the control device, a control loop is realized with feedback of a vehicle position, which can be preferably activated and/or deactivated as needed.

The driving motion is preferably a forward or backward movement of the vehicle. It can be preferably generated by the torque of the drive unit of the vehicle and its direction is preferably determined by the instantaneous steering angle.

A vehicle position is preferably a relative vehicle position, whose actual value can be determined or is determined, e.g., by onboard angle sensors (in particular, resolver, communication sensor, or rotary encoder, e.g., each mounted on a vehicle wheel/hub or an axle) and/or optical means (e.g., ground camera) and/or rotational speed sensors with time evaluation. Alternatively or additionally, a vehicle position is absolute (e.g., with reference to world coordinates) and can be determined by a positioning system, e.g., by GPS. Preferably, the system according to the invention is designed to determine and/or to receive a relative and/or absolute vehicle position. In an especially preferred way, the system is designed to combine the signals of at least one angle sensor and one steering angle sensor (sensor that measures the rotational state of the steering column and/or the positioning state of the steering rod and/or the angle of a steerable tire) and to evaluate the additional directional information and/or to consider it in the regulation. In this way, the vehicle can be positioned even more flexibly and/or a motion component can be calculated in a certain direction (e.g., forward, backward, to the right, and/or to the left). Preferably, the signal of at least one ABS sensor can also be evaluated for even more reliable determination of a vehicle position.

In another embodiment according to the invention, the system 1 is designed to obtain an actual value of a vehicle position by a signal of an angle sensor and to include it in the position control. In another method according to the invention, the step is also performed:
obtaining an actual value of a vehicle position by the signal of an angle sensor, and when performing the position control, the actual value of the vehicle position is included.

In this way, a relative vehicle position with high accuracy in the cm or even mm range can be used in the regulation as an actual value, with which the quality of the regulation is improved. The positional actual value is included as a regulation actual value—i.e., compared with the desired value. The angle sensor is preferably a resolver, commutation sensor. Preferably, the system has its own angle sensor. In an especially preferred way, the system is designed to use already present angle sensors. “Obtaining” is preferably a reception of a value that is already provided for a vehicle position. In an especially preferred way, “obtaining” also includes that the system is designed to calculate a vehicle position from the signal of the angle sensor.

For example, the position of the axle or a wheel is measured by the angle sensor. This value is received and from it a relative vehicle position (with respect, e.g., to the position at the time of the activation of the position control) is determined and used as an actual value in the control loop.

In another embodiment according to the invention, the system 1 also has an operating device 4 for the input of a position request and the system 3, preferably the control device 3, is designed to include the position request in the position control as a desired value. In another method according to the invention, the step is also performed
forwarding a position request input via an operating device 4 to the control device 3,
   and when performing the position control, the position request is included as a desired value.

In this way, a driver can directly and manually specify the desired value for the control, which enables a convenient and driver-intuitive use of the position control mode. For example, via the operating device, the driver enters that he or she would like to move, e.g., 10 cm forwards or, e.g., 1.23 m backwards.

The position request is preferably an input command of the driver, in order to move a certain position preferably forwards or backwards or to move the vehicle by this distance.

The operating device is preferably arranged or can be arranged within the reach of the driver, e.g., in the vicinity of the steering wheel (e.g., at a distance of at most 50 cm from the steering column). It is mounted or can be integrated, e.g., on the back or front of the steering wheel (e.g., as a lever or control console) or is integrated or can be mounted in the steering wheel. Preferably it is designed to generate and/or cause a visual and/or acoustic and/or tactile feedback concerning the input position request to the driver. Preferably the operating device has two components that are separated spatially from each other and can each be operated by one hand of the driver. In an especially preferred way, the operating device can be operated by one hand of the driver.

The control device includes the position request preferably as a desired value, in that the old desired value is replaced by the position request as the new control desired value. Preferably, the control device is designed to receive an input of a position request equally as a new desired value and to adapt the parameter until the desired value (under some circumstances, also a desired value changed again by another position request) and the actual value are equal.

In another embodiment according to the invention, the operating device 4 has operating elements 5, 6 and the system 1 is designed to forward a position request to the control device 3 only when at least two operating elements 5, 6 are actuated. In another method according to the invention, the position request is forwarded to the control device 3 only when at least two operating elements 5, 6 are actuated.

In this way, the likelihood of an incorrect operation or unintentional operation is reduced and thus a secure input is made possible.

Preferably an input is forwarded only when at least two operating elements were or are actuated within a certain time interval (see description of the system) or simultaneously.

An operating element is preferably an element from the group: touchpad, scroll wheel, switch with mechanically moving buttons, e.g., push-button, toggle switch, rocker switch, rotary switch, joystick, rotary or slide potentiometer, switch without mechanically moving buttons, e.g., contact switch.

The at least two operating elements contain preferably at least one operating element (preferably two operating elements) that can be used to input a position request, e.g., by which a magnitude of the actuation can be input (e.g., touchpad, scroll wheel, rotary or slide potentiometer, joystick) and at least one operating element with which the input of the position request can be actuated (e.g., touchpad, scroll wheel, rotary or slide potentiometer, joystick, switch with mechanically moving buttons, switch without mechanically moving buttons). Herein, any combination from these two lists is explicitly realizable in the scope of the invention. Preferably the position request is implemented only for the simultaneous actuation of both operating elements. For example, the system in the variants with one scroll wheel or touch pad and one switch is designed to assert an input of the position request only if the switch is pressed during the input with the scroll wheel/touch pad.

Preferably the system is designed to recognize an actuation of the operating device as a position request and forward it to the control device only if the at least two operating elements are actuated within a time interval, e.g., of 10 s, especially preferred 3 s, even more preferred 1 s. Preferably, the system has a circuit or a program that is designed to monitor the actuations of the operating device and to determine whether a (valid) position request has taken place or is taking place.

In another embodiment according to the invention, the system 1 is designed to forward the position request to the control device 3 only when the at least two operating elements 5, 6 are actuated in opposite directions. In another method according to the invention, the position request is forwarded to the control device 3 only when the at least two operating elements 5, 6 are actuated in opposite directions.

In this way, an intuitive and ergonomic operation of the operating device is achieved with simultaneously further increased safety (protection from unintentional operation). Opposite directions are preferred when two opposite directions of movement from the viewpoint of the driver or the operator of the operating device are performed for actuating the operating elements. For example, opposite directions are the direction pairs upward vs. downward, to the right vs. to the left, forward or away from vs. backward or toward, clockwise vs. counterclockwise, as well as mixed forms (e.g., diagonally upward to the right vs. diagonally downward to the left, diagonally downward to the right vs. diagonally upward to the left)—each from the viewpoint of the operator.

In another embodiment according to the invention, the at least two operating elements 5, 6 are arranged on two different sides of the operating device 4 or a steering wheel of the motor vehicle 2. In another method according to the invention, for the actuation of the at least two operating elements 5, 6, at least one operating element 5, 6 is actuated via one side of the operating device 4 or of the steering wheel of the motor vehicle 2 and at least one operating element 5, 6 is actuated via an other side of the operating device 4 or of the steering wheel of the motor vehicle 2 different from this side.

In this way, additionally or alternatively by the spatial arrangement of the operating elements, the likelihood of an unintentional actuation of the operating device is reduced. Different sides are preferably opposite sides, e.g., front and back side of the operating device or of the steering wheel; or right and left of the operating device or of the steering wheel; or top and bottom of the operating device, or above and below the steering wheel—each from the viewpoint of the driver.

For example, one operating element is arranged to the left of the steering wheel (from the viewpoint of the driver) and another is arranged to the right of the steering wheel; or the operating elements are arranged above and below the steering wheel. In this way, an input of a position request can be performed only with two hands. Preferably the operating elements are set apart from each other more than an average width of a hand (maximum distance between thumb and little finger), e.g., more than 15 cm, preferably more than 25 cm, especially preferred more than 30 cm, which also has the result that an input of a position request can be performed only with two hands and thus a very high operating safety can be achieved with simultaneous ergonomics and intuitiveness.

In another example, the operating elements are arranged on the front and back side of the steering wheel or on a front and back side or top and bottom side of an operating device (e.g., a lever) behind the steering wheel or on the front and back side or top and bottom side of a non-rotating part of the steering column. Preferably, the operating elements are set apart from each other less than an average width of a hand, e.g., less than 20 cm, preferably less than 15 cm, especially preferred less than 5 cm. This way, an unintentional actuation, e.g., by the arm or elbow, is excluded, because the driver must grip the operating device or the steering wheel (with one hand or both hands), to actuate both operating elements. At the same time, an intuitive and ergonomic, one-handed actuation is possible.

In an especially preferred way, the at least two operating elements are, e.g., two scroll wheels or touch pads that are arranged on the front/back side or top/bottom side of an operating device or the steering wheel. Preferably, the system is designed to forward a position input only when the scroll wheels or touch pads are actuated in opposite directions, so that, as a result, the input of the position request can be performed only by a movement that resembles the rolling of a pin between the thumb and pointing finger and thus is very intuitive and ergonomic.

### BRIEF DESCRIPTION OF THE DRAWINGS

The invention will now be illustrated by figures using examples. Shown herein are

FIG. 1 a system according to the invention for driver assistance,

FIG. 2 a first embodiment of an operating device,

FIG. 3 a second embodiment of an operating device, and

FIG. 4 a third embodiment of an operating device.

### DETAILED DESCRIPTION OF THE PREFERRED EMBODIMENTS

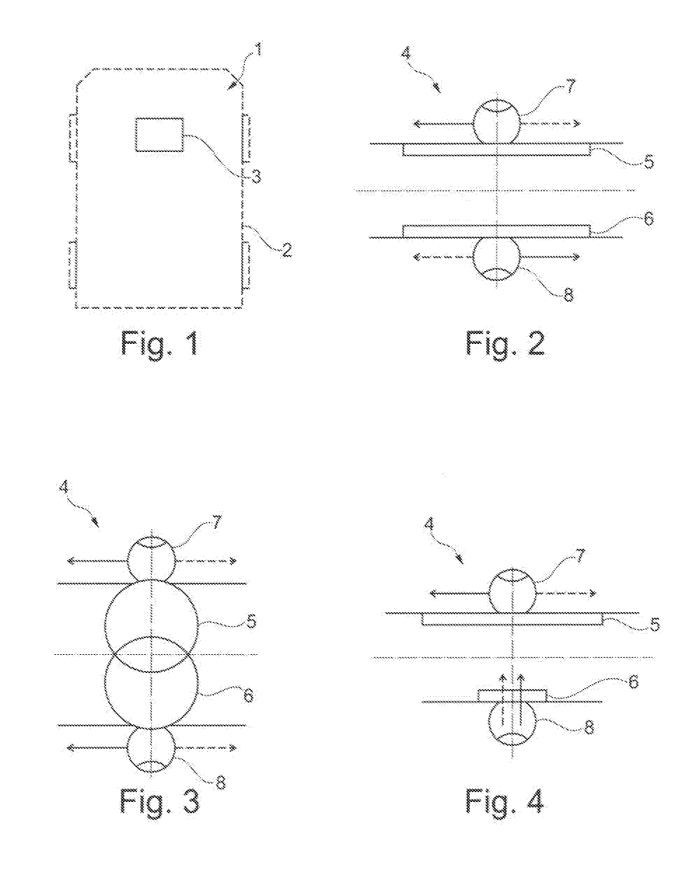

FIG. 1 shows a system 1 for driver assistance according to the invention. It has a control device 3 that can be arranged or is arranged in a motor vehicle 2. The control device 3 is designed to perform a position control of the driving movement of the motor vehicle 2.

In the operation of the invention (as needed, e.g., when the driver activates it), a position control of the driving movement of the motor vehicle is performed by the control device 3.

In this way, a simple and also safe maneuvering of the motor vehicle 2 is possible. Obstacles such as curbs that can cause difficulties in torque regulation can be overcome safely by the position control.

FIG. 2 shows a first embodiment of an operating device 4. The operating device 4 has two touch pads as operating elements 5, 6 on two opposite sides—here on the front side (operating element 6) and back side (operating element 5). The operating device 4 is, e.g., a section of the steering wheel, a lever, or a part not rotating with the steering wheel behind or in front of the steering wheel. The system 1 (not completely shown in FIGS. 2-4) is designed to receive a position request or to forward it to the control device only when both operating elements 5, 6 are actuated simultaneously or preferably within an interval of 2 s and when both operating elements 5, 6 are actuated in opposite directions. The solid arrow pair indicates the direction of motion of the fingers 7, 8 for the input of a position request for a driving movement in one direction. The dashed arrow pair indicates the direction of motion of the fingers 7, 8 for the input of a position request for a driving movement in the opposite direction. The system 1 is designed to convert the length or magnitude of the finger movement into a length or magnitude of the driving movement of the vehicle.

In the operation of the invention, the driver actuates the operating device 4 by touching at least one finger 7, 8 to each operating element 5, 6 and moving them over these elements in opposite directions (here, e.g., for a forwards driving direction: finger 7 to the left, finger 8 to the right). In this way he or she grips the operating device 4. The system checks whether movements on the operating elements 5, 6 are performed preferably within the corresponding time interval or simultaneously and in opposite directions. If this is the case, a position request is defined as a function of the magnitude of at least one movement, preferably at least two movements on the operating elements 5, 6 and forwarded to the control device of the system as a desired value. The desired value is compared with an actual value of the vehicle position and the vehicle position is regulated to the desired value through a movement of the vehicle.

In this way, an input for the position control is performed safely and ergonomically.

FIG. 3 shows a second embodiment of an operating device 4. This differs from FIG. 2 in that scroll wheels are provided as the operating elements 5, 6.

In contrast to the functioning of the operating device 4 of FIG. 2, the driver actuates the operating elements 5, 6 by he or she turning the scroll wheels and whether or not and what kind of position request is present is determined analogously from the magnitude of the turning.

In this alternative way, an input for the position control is similarly performed safely and ergonomically.

FIG. 4 shows a third embodiment of an operating device 4. This differs from FIG. 2 in that it has a button 6 instead of a touch pad. In addition, the system is not designed to accept or forward a position request to the regulator only when both operating elements 5, 6 are actuated in opposite directions. In this variant, the system is designed to accept or forward a position request to the regulator when the button 6 is actuated and the touch pad 5 is actuated simultaneously or preferably within a certain interval, e.g., 1 s.

In this way, the likelihood of an unintentional input of a position request is further prevented, the costs for the realization are lower and the operation might also be less complicated for some drivers while other drivers might prefer the variants from FIG. 2 or 3. Therefore, the individual driver wishes can be input through the selection of an operating device 4.

With this invention, for the first time, maneuvering is made easier for the driver of a vehicle and obstacles, e.g., curbs or uneven road surfaces no longer make maneuvering more difficult. In contrast to torque regulation (e.g., by the gas pedal actuated by the driver), according to the invention, a driver assistance system has been described as a solution that allows a driving mode in which the driving movements of the vehicle are regulated with respect to the position. Here, the system allows the driver to input a position request, i.e., a value that stands for a distance that the vehicle is to move forwards or backwards. Through the position control, obstacles that cause an increased drive torque to be overcome are compensated for automatically. The system thus represents a convenient and simultaneously precise aid during maneuvering. In addition, through an operating device according to the invention, a safe and ergonomic input of the position request is made possible. Preferably, a position request is triggered or actuated only through the actuation of at least two operating elements, wherein an unintentional actuation is avoided. In an especially preferred way, the actuation direction is also evaluated in order to then decide whether a valid input of a position request has taken place or not. This leads to further increased operating safety.

### LIST OF REFERENCE NUMBERS

1 System for driver assistance for a motor vehicle
2 Motor vehicle
3 Control device
4 Operating device
5 Operating element
6 Operating element
7 Finger
8 Finger

1. A system for driver assistance for a motor vehicle comprising a control device configured perform a position control of a driving motion of the vehicle.

2. The system according to claim 1, further comprising an angle sensor that signals the control device for determining an actual value of a vehicle position.

3. The system according to claim 1, further comprising an operating device for input of a position request and the control device is configured to include the position request in the position control as a desired value.

4. The system according to claim 3, wherein the operating device has operating elements and wherein the system is configured to forward the position request to the control device only when at least two of the operating elements are actuated.

5. The system according to claim 4, wherein the system is configured to forward the position request to the control device only when the at least two of the operating elements are actuated in opposite directions.

6. The system according to claim 5, wherein the at least two operating elements are arranged on two different sides of the operating device or of a steering wheel of the motor vehicle.

7. A method for assisting a driver of a motor vehicle comprising:
executing a position control of the driving motion of the vehicle by a control device.

8. The method according to claim 7, further comprising:
obtaining an actual value of a vehicle position by a signal of an angle sensor, and wherein, when the position control is performed, the actual value of the vehicle position is included.

9. The method according to claim 8, further comprising, wherein also the step is performed:
forwarding a position request input via an operating device to the control device,
and wherein, when performing the position control, the position request is included as a desired value.

10. The method according to claim 9, wherein the position request is forwarded to the control device only when at least two operating elements of the operating device are actuated.

11. The method according to claim 10, wherein the position request is forwarded to the control device only when the at least two operating elements are actuated in opposite directions.

12. The method according to claim 11, wherein, for the actuation of the at least two operating elements, at least one of the operating elements is actuated via one side of the operating device or of a steering wheel of the motor vehicle and at least one of the operating elements is actuated via an other side of the operating device different from said one side or of the steering wheel of the motor vehicle.
